(19) United States
(12) Patent Application Publication
(10) Pub. No.: US 2007/0223022 A1
(43) Pub. Date: Sep. 27, 2007

(54) PRINTING APPARATUS

(76) Inventor: Takeshi Suzuki, Fukushima (JP)

Correspondence Address: RABIN & Berdo, PC, 1101 14TH STREET, NW, SUITE 500, WASHINGTON, DC, 20005, US

(21) Appl. No.: 11/678,801

(22) Filed: Feb. 26, 2007

(30) Foreign Application Priority Data
Mar. 24, 2006 (JP) JP2006-083201

(51) Int. Cl. G06K 15/00

(52) U.S. Cl. 358/1.12; 358/537

(57) ABSTRACT

A printing apparatus for continuously printing first and second image data onto first and second recording media has: a data forming portion which forms blank data corresponding to an interval between the first and second image data and couples those data; a detecting section which detects positions of the media; a deviation detecting section which detects a deviation on the basis of the detected positions; a blank data correcting section which corrects the blank data in accordance with the detected deviation amount; and a data transfer section which transfers the coupled image data to a print section. A gap between print units upon continuous printing can be minimized.

### BACKGROUND OF THE INVENTION

1. Field of the Invention

The invention relates to a printing apparatus which continuously executes printing on a predetermined print unit basis.

2. Description of the Related Art

A printing apparatus executes printing onto a print medium on a predetermined print unit basis on the basis of image data.

For example, when printing onto a continuous sheet, control is made in such a manner that when the printing of one print unit is finished, transfer of the image data to a print section is temporarily stopped, the transfer of the next image data to the print section is restarted in accordance with a head position of the next print unit, and an image is printed.

The print section which has received the image data executes a printing process onto the print medium on the basis of the image data. At this time, a mechanism control section makes conveyance control of the print medium in association with the printing process.

A printer has been disclosed as a printing apparatus in JP-A-2003-25656 and there has been disclosed a technique for correcting a deviation caused by expansion/contraction of a recording medium, an error of a driving system in a conveying path of the medium, or the like.

However, in the conventional printing apparatus, the image data is sent to the print section on a print unit basis and when the printing process based on the image data is executed by the print section, after the transfer of the image data to a print head and an exposure of the head in association with the transfer are stopped, they are restarted. Therefore, an idle time occurs between the stop and the restart and a blank portion of a conveyance distance corresponding to the idle time, that is, an interval of each print unit is necessary.

In the conventional printing apparatus, for example, during the printing onto the continuous sheet at a conveying speed of 100 mm/sec, the transfer of the image data of a first print unit to the print section is finished and stopped, the image data of the second print unit is transferred in accordance with the head position of the second print unit, and the printing is restarted. Therefore, assuming that the time which is required from the stop to the restart is equal to 200 msec, the blank portion corresponding to 20 mm occurs. Such a time of 200 msec is a time which is necessary for the stopping process and the starting process (writing into a register, various calculating processes). There is such a problem that an interval (gap) between the first print unit and the second print unit is enlarged due to the occurrence of the blank portion corresponding to 20 mm.

### SUMMARY OF THE INVENTION

It is, therefore, an object of the invention to provide a printing apparatus which can minimize a gap between print units in the continuous printing.

According to the present invention, there is provided a printing apparatus for continuously printing first image data and second image data onto a first recording medium and a second recording medium, comprising a data forming portion which forms blank data corresponding to an interval between the first image data and the second image data and couples the first image data with the second image data by the blank data; and a data transfer section which transfers the coupled image data to a print section.

Moreover, the printing apparatus may further comprise a detecting section which detects positions of the recording media; a deviation detecting section which detects a deviation on the basis of the positions of the first recording medium and the second recording medium detected by the detecting section; and a blank data correcting section which corrects the blank data in accordance with the deviation amount detected by the deviation detecting section.

Moreover, in the printing apparatus, the blank data correcting section may increase or decrease the number of lines for the deviation correction, on the basis of preset print resolution.

Moreover, in the printing apparatus, the detecting section may be arranged at a position away from the print section by a predetermined distance in a conveying path for conveying a continuous sheet to the print section and while a printing process is being executed to the preceding recording medium, the detecting section may detect a head position of the subsequent recording medium.

Moreover, in the printing apparatus, the first recording medium and the second recording medium may be label papers placed on a continuous paper.

Moreover, in the printing apparatus, the detecting section may detect marks set on the recording media; and the deviation detecting section may detect the deviation amount according to an interval of marks detected by the detecting section and an interval of regular marks.

According to the printing apparatus of the invention, the data forming portion forms the interval, as blank data, between the first print unit and the second print unit and forms the first image blank data obtained by adding the blank data to the first image data. When the detecting portion detects the print start position in the first print unit, the print section prints onto the print medium on the basis of the first image blank data. Therefore, subsequent to the printing process based on the first image data, the print section is continuously notified of the virtual printing process based on the blank data.

That is, subsequent to the printing process based on the first image data, the print section executes the virtual printing process based on the blank data and, further, can execute the printing process based on the second image data without interruption. There is no need to stop the operation of the driving system and the operation of the conveying system and the printing process is continuously executed. Therefore, since there are no stop and restart of the transfer of the image data to the print section, the interval between the first print unit and the second print unit can be narrowed to the minimum value.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a functional block diagram of a printing apparatus of an embodiment 1;

FIG. 2 is a cross sectional view of the printing apparatus of the embodiment 1;

FIG. 3 is a diagram showing an example of a print medium (continuous sheet);

FIGS. 4A and 4B are diagrams showing an example of images which are printed and a print result;

FIGS. 5A and 5B are flowcharts of the printing apparatus of the embodiment 1;

FIG. 6 is a cross sectional view of a printing apparatus of an embodiment 2; and

FIG. 7 is a flowchart showing the print processing operation of a first print unit of the printing apparatus of the embodiment 2.

### DETAILED DESCRIPTION OF THE PREFERRED EMBODIMENTS

Embodiments of the invention will be described in detail with reference to the drawings. In the following explanation, the same component elements in the drawings which are used in the embodiments are designated by the same reference numerals and their overlapped explanation is omitted as much as possible.

### Embodiment 1

An embodiment 1 of the invention will be described in detail hereinbelow with reference to the drawings.

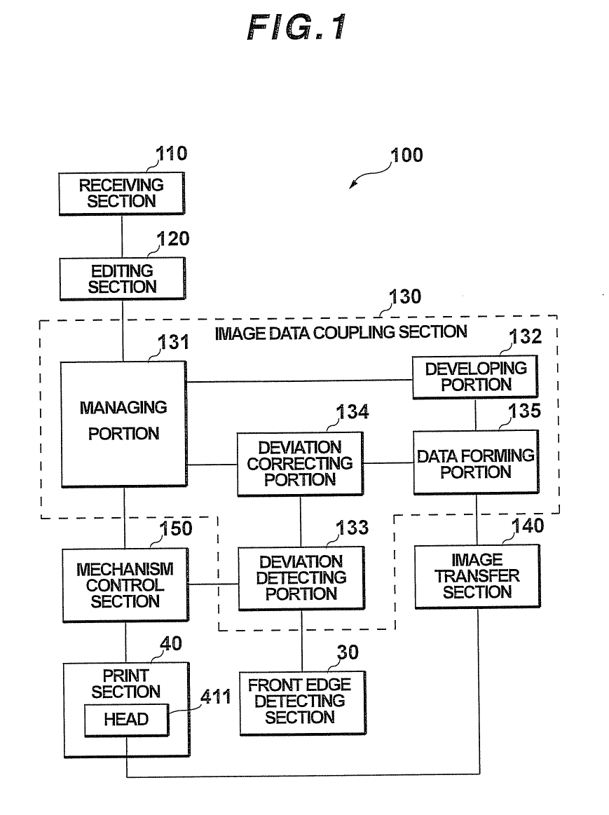

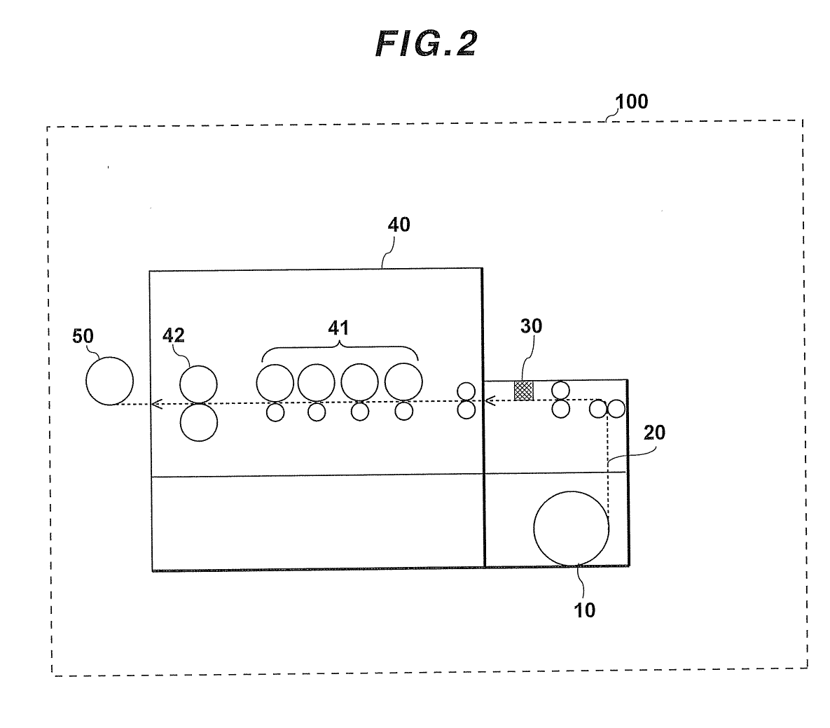

Prior to explaining a printing apparatus 100 of the embodiment 1 in detail with reference to a functional block of FIG. 1, an outline of a mechanism of the printing apparatus 100 will be explained with reference to a cross sectional view of FIG. 2.

The printing apparatus 100 has: a continuous sheet storing section 10 for feeding a continuous sheet; a sheet conveying path 20 for conveying the fed continuous sheet to a print section 40; a front edge detecting section 30 for detecting a head position (or a mark) of a label on the continuous sheet; the print section 40 for forming images onto the continuous sheet on the basis of image data; and a winding section 50 for winding the continuous sheet to a downstream of the print section.

The front edge detecting section 30 has an optical sensor (not shown). This sensor irradiates light onto the continuous sheet, measures an intensity of the reflection light from the continuous sheet, and detects the front edge position of the label on the basis of a change in intensity of the reflection light from a stairway difference between the continuous sheet and each of the labels attached on the continuous sheet at regular intervals.

The front edge detecting section 30 forms a front edge position signal showing the detected front edge position of the label and outputs the formed front edge position signal to a deviation detecting portion 133.

The print section 40 has: a developing and transfer portion 41 for forming a toner image on the basis of the image data and transferring the toner image onto the continuous sheet; and a fixing portion 42 for fixing the transferred toner image onto the continuous sheet. The developing and transfer portion 41 has: a head for forming an electrostatic latent image onto a photosensitive body on the basis of the image data; a developing device for supplying toner to the electrostatic latent image on the photosensitive body and developing as a toner image; and a transfer portion for forming a mirror image of the toner image onto a print medium.

In the print section 40, a head is provided for each photosensitive body. The print section 40 has: a positioning mechanism for positioning each head to each photosensitive body; a rotating mechanism for rotating the cylindrical photosensitive body on which the electrostatic latent image is formed by the head; and a conveying mechanism for conveying the print medium to a predetermined position. There is a risk of occurrence of a positional deviation of the head due to the positioning mechanism, a positional deviation of a photosensitive drum due to the rotating mechanism, and a positional deviation of the print medium due to the conveying mechanism.

In the toner image which is formed, a dot train which is formed in a minor direction, that is, the column (lateral) direction in the case of conveying the sheet in the state where the minor direction in, for example, the A4 size is set to the head is called a line, and a subsequent explanation will be made. The white line denotes a dot train in which no toner image is formed.

As shown in FIG. 1, a functional block construction of the printing apparatus 100 comprises: a receiving section 110 for receiving print data from a host computer (not shown); an editing section 120 for editing the print data, in a predetermined print unit, received by the receiving section 110; an image data coupling section 130 for forming the interval, as blank data, between the first print unit and the second print unit so as to couple the first image data and the second image data and forming the first image blank data obtained by adding the blank data to the first image data; an image transfer section 140 for transmitting the image data to a head 411 of the print section 40; and a mechanism control section 150 for making conveyance control of the print medium in accordance with a standard of the print medium.

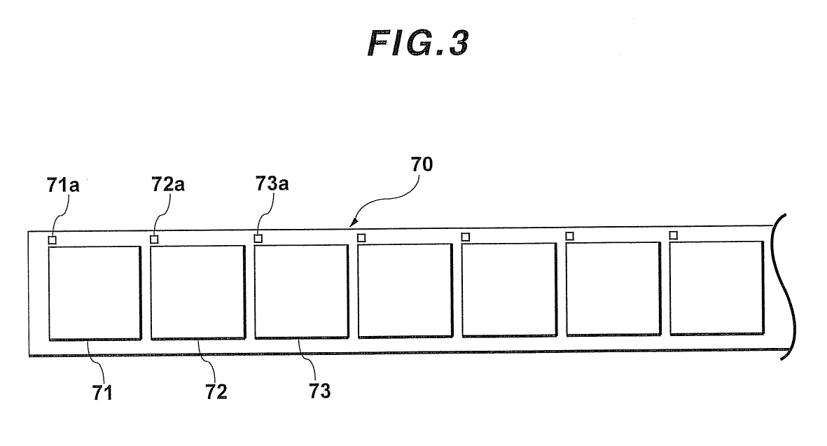

As for the continuous sheet stored in the continuous sheet storing section 10, as shown in FIG. 3, a plurality of labels 71, 72, 73, . . . are attached onto the continuous sheet at regular intervals. Marks 71a, 72a, 73a, . . . showing positions of those labels are written on the continuous sheet at similar regular intervals. The position of each label can be recognized by a stairway difference between a continuous sheet 70 and each label or may be recognized by detecting the marks 71a, 72a, 73a, . . . .

The position of each label corresponds to the foregoing predetermined print unit on the continuous sheet. Specifically speaking, the printing process to one label is executed as one print unit.

Setting information showing a size of continuous sheet, a label size, a label interval, and the like has been set through an operating section (not shown). Information such as a print unit and the like corresponding to the label size and label interval is included in the setting information.

The mechanism control section 150 controls, in a lump, a scanning mechanism of each head, the rotating mechanism of the photosensitive body, and the conveying mechanism of the print medium and transmits a signal indicative of a predetermined print unit to the deviation detecting portion 133, which will be explained hereinafter, on the basis of the setting information.

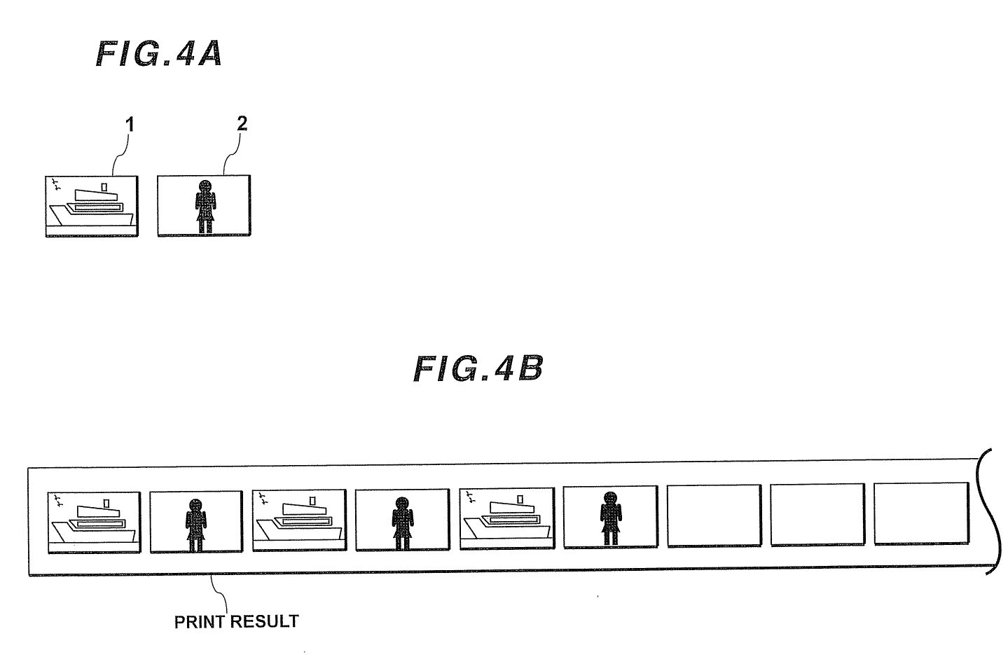

In the printing apparatus 100 of the embodiment 1, an example in which three sets each comprising an image 1 and an image 2 are continuously printed onto the continuous sheet as shown in FIG. 4A will be described. As a print result, as shown in FIG. 4B, both of the image 1 and the image 2 are accurately printed in the range of each label.

The image data coupling section 130 has: a managing portion 131 for managing the data from the editing section by printing order in the predetermined print unit; a developing portion 132 for forming bit map image data from the data of the predetermined print unit; the deviation detecting portion 133 for receiving the signal from the front edge detecting section 30 and detecting a deviation of the position of the continuous sheet medium; a deviation correcting portion 134 for calculating a correction value for returning the continuous sheet medium from the deviated position to a normal position and outputting the correction value; and a data forming portion 135 for forming blank data, which will be explained hereinafter, serving as white line in the print result on the basis of an initial value which has previously been held and the correction value from the deviation correcting portion 134 and adding to the image data.

The managing portion 131 manages, in print order, the data which has been edited on a print unit basis and manages excess or deficiency of the number of pages which has been caused by the correction of the print position.

The developing portion 132 forms the bit map image data from the data of the print unit. After the first bit map image data was formed and sent to the data forming portion 135, the creation of the second bit map image data is subsequently started. After the second bit map image data was formed and sent, the creation of the third bit map image data is started. In this manner, so long as the data from the managing portion 131 exists, the above processes are repeated and the bit map image data is sent to the data forming portion 135 without interruption.

When the deviation detecting portion 133 receives a print unit signal showing a conveying speed s of the print medium and a distance D from the front edge of the label to the front edge of the next label from the mechanism control section 150, it obtains a standard time difference T (=D/s). When the deviation detecting portion 133 receives a head position signal showing the head position of the label of the continuous sheet detected by the front edge detecting section 30, it obtains a detection time difference t from the head position signal to the next head position signal and calculates a difference (time difference Δt=T−t) between the detection time difference t and the standard time difference T (=D/s). The deviation detecting portion 133 outputs the time difference Δt as a deviation signal to the deviation correcting portion 134.

When the deviation correcting portion 134 receives the deviation signal from the deviation detecting portion 133, it calculates a deviation (distance s*Δt) on the basis of the deviation signal (time difference Δt) and the conveying speed s of the continuous sheet. That is, the deviation correcting portion 134 sends the calculated deviation (distance s*Δt) as a correction value to the data forming portion 135.

When the data forming portion 135 receives the correction value (distance=s*Δt) from the deviation correcting portion 134, it forms bit map image data (bit map image data showing a blank), as blank data, of an amount corresponding to the white lines according to the correction value (distance=s*Δt) and forms image blank data (first image blank data) obtained by coupling the formed blank data with a rear edge of the bit map image data. Further, the data forming portion 135 couples the second bit map image data with a rear edge of the formed image blank data (first image blank data).

When the data forming portion 135 forms the image blank data of one print unit, it notifies the managing portion 131 of such a fact in order to coincide the conveying timing of the print medium with the timing for the printing process in the print section 40.

An example of the operation of the data forming portion 135 will now be specifically explained.

The printing apparatus 100 has an ability of a print resolution of 400 dpi. When the deviation (distance) of the continuous sheet is equal to + 1/100 inch, 400 dpi * 1/100 inch=4. In order to increase the white lines of 4 lines, the printing apparatus 100 forms bit map image data showing the blank of 4 lines as blank data.

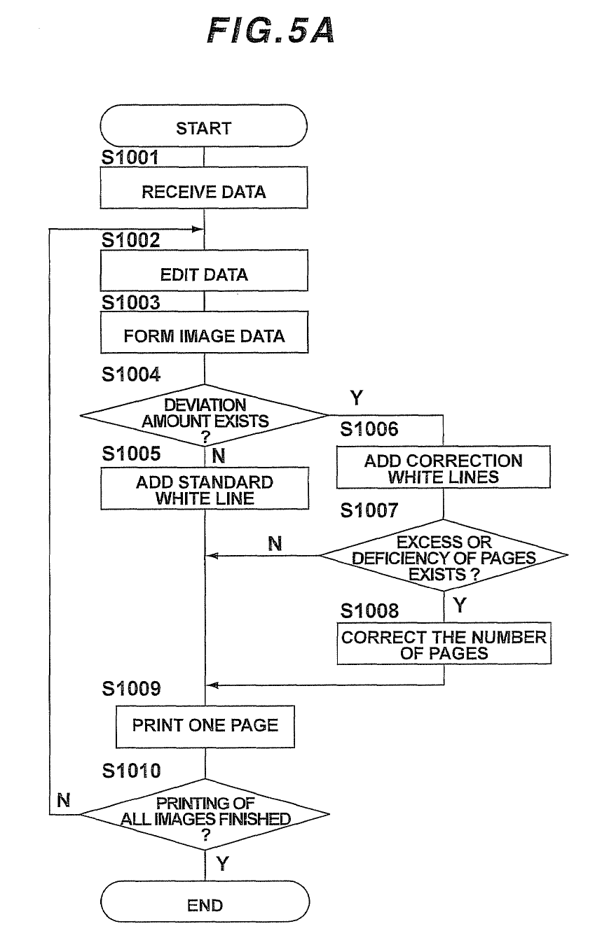

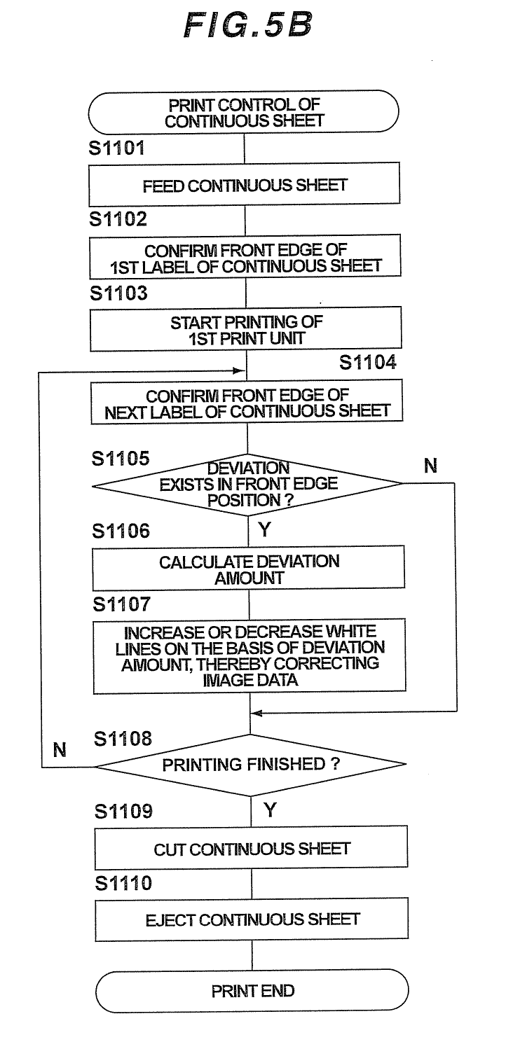

The operation of the printing apparatus 100 in the embodiment 1 will now be described with reference to FIGS. 5A and 5B.

The receiving section 110 receives the print data from an upper apparatus and sends the print data to the editing section 120 (step S1001). When the editing section 120 receives the print data, it edits the print data into the predetermined print unit (label size) S1002).

When the developing portion 132 receives the data which has been edited into the predetermined print unit, it develops the image on the basis of the data and forms the image data (S1003). The deviation detecting portion 133 discriminates whether or not there is a deviation in the position of the continuous sheet medium on the basis of the print unit signal from the mechanism control section 150 and the head position signal from the front edge detecting section 30 (S1004). The print unit signal is formed on the basis of the sheet standard (size) of the print medium. For example, if a plurality of labels 71, 72, 73, . . . are attached onto the continuous sheet at regular intervals as shown in FIG. 3, the print unit signal is formed on the basis of the size of each label and the interval between the labels.

If there is no deviation, the data forming portion 135 adds the white lines of the standard number of lines which is calculated from the label interval distance and the conveying speed to the rear edge of the image data and sets the image data into the image data of one print unit (S1005).

If the deviation exists, the data forming portion 135 adds the data corresponding to the white lines in which the number of lines corresponding to the distance (=time difference×conveying speed) has been increased or decreased to the standard number of lines to the rear edge of the image data and forms the image data as image data of one print unit (S1006).

The managing portion 131 discriminates whether or not an excess or deficiency has occurred in the print unit by the increase or decrease in white lines of the data forming portion 135 (S1007). If the excess or deficiency has occurred in the print unit, the managing portion 131 adds or deletes the print unit (page) and calculates a difference between the number of pages from the upper apparatus and the number of pages of the printing (S1008).

Explanation will be made here with respect to an example in which when the print data of four pages is being printed, the managing portion 131 has determined that the deficiency has occurred in the print unit (page) and has added the print unit (page).

For example, when the interval (the number of white lines) between the label and the next label is equal to 2 mm, if a slip of 1 mm per page occurs due to a slip of the continuous sheet, the correction value at the fourth page is equal to 3 mm. In the case of the number of pages designated by the reception data, since the image data cannot be stored, the managing portion 131 internally adds one page. Since the number of pages of the reception data differs from the number of print pages, the managing portion 131 separately manages them.

The print section 40 executes the printing by using the formed image data as a print unit (S1009).

The managing portion 131 discriminates whether or not all of the printing processes based on the print data from the upper apparatus have been finished (S1010).

If all of the printing processes of the print data have been finished, the processing routine is finished. If the printing is not completed, the processing routine is returned to S1002 in order to print the residual data and the subsequent processes are repeated until the residual data does not exist.

Since the continuous sheet printing has been set in the embodiment, the following processes are executed (refer to FIG. 5B).

First, in order to execute the printing process of the first print unit, the continuous sheet is fed to prepare for the printing process (S1101).

When the sheet is fed and the front edge detecting section 30 detects the head position of the first label of the continuous sheet (S1102), it outputs the head position signal to the print section.

When the print section 40 receives the head position signal from the front edge detecting section 30, it executes the printing process onto the first label on the basis of the image data of the amount of the first print unit formed by the data forming portion 135 (S1103).

Subsequently, in order to execute the printing process of the second print unit, the front edge detecting section 30 detects the head position of the second label of the continuous sheet (S1104). The deviation detecting portion 133 which received the head position signal indicative of the head position from the front edge detecting section 30 discriminates whether or not there is a time difference (deviation) in the head position signal indicative of the second label on the basis of the print unit signal from the mechanism control section 150 and the head position signal (S1105).

If there is no deviation, the printing process is executed in the print section 40 on the basis of the image data of the second print unit to which the foregoing adding process of the standard white line has been executed. If the deviation exists, the deviation correcting portion 134 calculates the distance (=time difference×conveying speed) (S1106). The data forming portion 135 executes the white line process in which the number of lines has been increased or decreased in correspondence to the distance and forms the image data corresponding to the second print unit as image data of one print unit (S1107).

The print section 40 executes the printing process on the basis of the formed image data.

When the printing process of one print unit is finished, the managing portion 131 discriminates whether or not the image data of the next print unit exists. If the image data exists, the managing portion 131 receives the image data of one print unit and executes the printing process on the basis of the image data. If the image data does not exist, the processing routine advances to a cutting process of the continuous sheet in order to finish the continuous sheet printing (S1108).

To finish the printing process, the fed continuous sheet is cut (S1109).

When the ejection of the cut sheet is confirmed, the printing process is finished (S1110).

According to the printing apparatus 100 in the embodiment 1, since the image data coupling section 130 executes the white line process in which the number of lines has been increased or decreased on the basis of the time difference (deviation) of the head position of the label, forms the image data (image blank data) of one print unit, and notifies the print section 40 of it, the image data +blank data+image data+blank data+ . . . are continuously transferred to the print head of the print section. Thus, the data can be printed at the minimum label intervals.

The image data coupling section 130 forms the image data of one print unit in order to couple the image data of a plurality of print units by the white line process and continuously sends the formed image data to the print section 40 in order from the first print unit. A time which is necessary to execute the printing process without stopping the driving system and the conveying system is shorter than a time which is necessary to execute the printing process by controlling so as to stop and restart the driving system and the conveying system. There is no time lag. Therefore, the continuous printing can be executed at a high speed and the printing time can be shortened.

### Embodiment 2

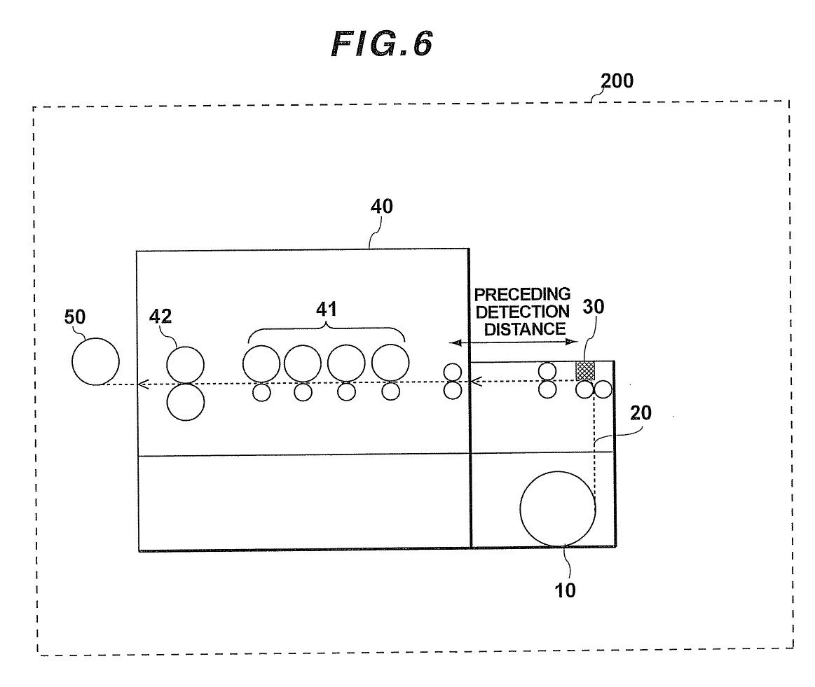

An outline of a mechanism of a printing apparatus 200 of an embodiment 2 will now be described with reference to a cross sectional view of FIG. 6.

The printing apparatus 200 comprises: the continuous sheet storing section 10 for feeding the continuous sheet; the sheet conveying path 20 for conveying the fed continuous sheet to the print section 40; the front edge detecting section 30 for detecting the head position (or mark) of the label on the continuous sheet; the print section 40 for forming the images onto the continuous sheet on the basis of the image data; and the winding section 50 for winding the continuous sheet to the downstream of the print section.

A feature of the embodiment 2 will now be described.

The front edge detecting section 30 for detecting the head position (or mark) of the label on the continuous sheet is arranged at a position away from the print section 40 by a predetermined distance L (preceding detection distance) in the conveying path for conveying the continuous sheet to the print section 40 and detects the head position (head position of the print medium upon page printing) of the label prior to executing the printing process. Thus, while a print preparing process is executed to the preceding label, a deviation of the head position of the subsequent label is calculated and can be reflected to the blank data.

When the image data coupling section 130 receives the head position signal of the preceding label and the head position signal of the subsequent label from the front edge detecting section 30, it obtains the time difference t between the head position of the preceding label and the head position of the subsequent label and calculates a deviation amount between the time difference t and the standard time difference T (=D/s). The correction to increase or decrease the number of necessary white lines is executed on the basis of the calculated deviation amount while the print preparing process is executed to the preceding label.

The predetermined distance (preceding detection distance)L will now be described.

The time which is necessary until the following processes are executed is assumed to be T2: that is, after the image data coupling section 130 received the front edge detection signal of the preceding label from the front edge detecting section 30, it receives the front edge detection signal of the subsequent label, the time difference t between the head position of the preceding label and the head position of the subsequent label is obtained, the deviation amount between the time difference t and the standard time difference T (=D/s) is calculated, the white line process in which the number of necessary white lines has been increased or decreased is executed on the basis of the calculated deviation amount, the image data (image blank data) of preceding one print unit is formed, and the print section 40 is notified of the image blank data through the image transfer section 140. The conveying speed of the continuous sheet is assumed to be s. The predetermined distance L is calculated by (L=s*T2).

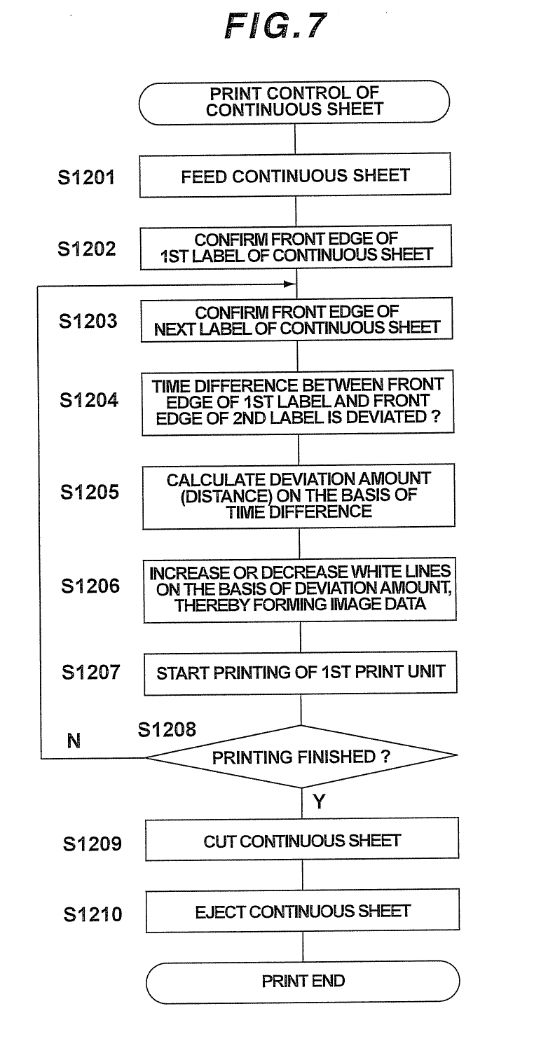

The operation of the printing apparatus 200 of the embodiment 2 will now be described. Particularly, the printing process in the continuous sheet as a feature of the embodiment will be explained with reference to a flowchart of FIG. 7.

First, in order to execute the printing process by the first print unit, the continuous sheet is fed to prepare for the printing process (S1201).

When the sheet is fed, the front edge detecting section 30 detects the head position of the first label of the continuous sheet (S1202).

The foregoing image data is image data before the white line process described in the embodiment 1 is executed. While the print preparing process based on the image data is being executed, the white line process is executed. Consequently, the printing apparatus 200 executes the printing process on the basis of the image data to which the white line process has been executed.

The operation of the printing process will now be described mainly with respect to the white line process.

First, the front edge detecting section 30 detects the head position of the second label of the continuous sheet (S1203). The deviation detecting portion 133 which has received the second head position signal from the front edge detecting section 30 obtains the time difference between the first head position signal and the second head position signal, compares the obtained time difference with a predetermined reference unit time, and discriminates whether or not the obtained time difference is deviated from the reference unit time (S1204). The reference unit time is supplied as a print unit signal. The comparison is made on the basis of the print unit signal and the signal indicative of the time difference between the first head position signal and the second head position signal.

If there is no deviation, the printing process is executed in the print section 40 on the basis of the image data of the first print unit in which the foregoing adding process of the white lines has been performed. On the other hand, if the deviation exists, the deviation correcting portion 134 calculates the distance (=time difference×conveying speed) (S1205). The data forming portion 135 executes the white line process in which the number of lines has been increased or decreased in correspondence to the distance and forms the image data corresponding to the first print unit as image data of one print unit (S1206).

The image data coupling section 130 outputs the image data of the first print unit formed in the data forming portion 135 to the print section. The print section 40 which has received the image data starts the printing process onto the first label on the basis of the image data of the first print unit (S1207). The print section 40 executes the printing process on the basis of the received image data.

The managing portion 131 discriminates whether or not the printing process is finished (S1208). If all of the printing processes are not finished, the processing routine from step S1203 mentioned above is repeated. If all of the printing processes have been finished, the cutting process of the fed continuous sheet is executed (S1209). When the cut sheet is ejected, the printing process is finished (S1210).

According to the printing apparatus 200 of the embodiment 2, during the print preparing process of the preceding first label, the head position of the subsequent second label is detected, the time corresponding to the print unit in the first label is obtained on the basis of the detection signal of the head position of the first label and the detection signal of the head position of the second label, and the deviation between the obtained time and the predetermined reference unit time is discriminated. Therefore, the white line process is executed in accordance with the deviation (amount) in one print unit and the correction to increase or decrease the number of white lines can be made during the printing process of the first label.

Since the length of one print unit of the print medium can be measured before completion of the printing process of one print unit, even if a medium such as folding paper or the like which has been partitioned at irregular intervals along a perforation is used, the length of one print unit can be measured before printing, so that the printing process can be executed without a positional deviation.

Although the embodiments 1 and 2 have been described above with respect to the printing process to the continuous sheet, the invention can be also applied to a page printing for continuously printing a plurality of cut sheets such as A4-size paper.

Although the embodiments 1 and 2 have been described above with respect to the example in which one mark has been added to the head position per label with respect the number of attached marks and their attaching positions, the number of attached marks and their attaching positions may be set to other proper value and positions in order to raise a detecting precision of the position.

It should be understood by those skilled in the art that various modifications, combinations, sub-combinations and alterations may occur depending on design requirements and other factors insofar as they are within the scope of the appended claims or the equivalents thereof.

What is claimed is:

1. A printing apparatus for continuously printing first image data and second image data onto a first recording medium and a second recording medium, comprising:
a data forming portion which forms blank data corresponding to an interval between said first image data and said second image data and couples said first image data with said second image data by said blank data; and
a data transfer section which transfers said coupled image data to a print section.

2. The printing apparatus according to claim 1, further comprising:
a detecting section which detects positions of said recording media;
a deviation detecting section which detects a deviation on the basis of the positions of said first recording medium and said second recording medium detected by said detecting section; and
a blank data correcting section which corrects said blank data in accordance with the deviation amount detected by said deviation detecting section.

3. The printing apparatus according to claim 2, wherein on the basis of preset print resolution, said blank data correcting section increases or decreases the number of lines for the deviation correction.

4. The printing apparatus according to claim 2, wherein said detecting section is arranged at a position away from said print section by a predetermined distance in a conveying path for conveying a continuous sheet to said print section and while a printing process is being executed to the preceding recording medium, said detecting section detects a head position of the subsequent recording medium.

5. The printing apparatus according to claim 1, wherein said first recording medium and said second recording medium are label papers placed on a continuous paper.

6. The printing apparatus according to claim 2, wherein said detecting section detects marks set on said recording media; and said deviation detecting section detects the deviation amount according to an interval of marks detected by said detecting section and an interval of regular marks.
